(19) United States
(12) Patent Application Publication
(10) Pub. No.: US 2026/0035173 A1
(43) Pub. Date: Feb. 5, 2026

(54) Trash Caddy Lid Indicator

(71) Applicant: Marketing Holders LLC (DBA 321 Plastics), Mims, FL (US)

(72) Inventor: Arthur Crowley, Mims, FL (US)

(21) Appl. No.: 19/283,801

(22) Filed: Jul. 29, 2025

Related U.S. Application Data
(60) Provisional application No. 63/677,097, filed on Jul. 30, 2024.

(51) Int. Cl. B65F 1/14; B65F 1/02; B65F 1/16

(52) U.S. Cl. CPC B65F 1/1484; B65F 1/02; B65F 1/1473; B65F 1/16; B65F 2210/138

(57) ABSTRACT

Devices, systems and methods for providing a mechanical flag indicator device that can be used to keep a refuse container lid closed, while being in a down position or in a raised position prevents the lid from being raised to a vertical position perpendicular to a top of the container. When the refuse container is turned upside down to be emptied, the hinged lid on the refuse container opens up to a less 90 degree position limited by the flag indicator moves to its' limited raised position. When the refuse container is turned right side up, the flag indicator remains in the raised position, which indicates to the user/consumer that the refuse container has been emptied. Overtime the lid will fall back on its' own weight to close over the top opening to the refuse container.

### CROSS REFERENCE TO RELATED APPLICATIONS

This application claims the benefit of priority to U.S. Provisional Application Ser. No. 63/677,097 filed Jul. 30, 2024, the entire disclosure of which is incorporated herein by specific reference thereto.

### FIELD OF INVENTION

This invention relates to refuse containers, and in particular to, devices, systems and methods for providing a mechanical flag indicator device that can be used to keep a refuse container lid closed, while being in a down position, and flag indicator device having a raised position which prevents the lid from being raised to a vertical position perpendicular to a top of the container, so that the lid can easily fall back to a closed position on the refuse container.

### BACKGROUND AND PRIOR ART

Trash bin alert flags have been sold over the years which are similar to those used on mailboxes, and the like, where a pivotal flag or colored rectangular panel can be raised to let alert when the trash container is full and is ready to be picked up. However, these pivotal flags/panels do not cover over the lid of the trash container. So, wind can often raise the trash container lid, which allows refuse to fall out and litter grounds around the trash container.

Devices have been proposed over the years to latch down lids on trash containers. See for example, U.S. Pat. No. 3,137,408. However, this device does not signal nor flag third parties that a trash container is full and needs to be picked up.

Some more recent devices have provided a flag type indicator that signals to third parties that a trash container is full and needs to be picked up. See for example, U.S. Pat. No. 6,295,946 to Kasik and U.S. Published Patent Application 2024/0116701 to Deschamps et al. However, there are some problems with these devices.

Deschamps et al. '701 requires a spring to keep the lid down, which is separate from a flag indicating the trash container is full and needs to be picked up.

Kasik '946 uses a flag signaling device which is initially oriented on top of a trash container lid. Raising the lid causes the flag device to move upward to a stop which allows the flag signaling device to stay vertical as a signaling indicator the trash container is full and needs to be picked up. The weight of the flag signaling device keeps it in a raised vertical signaling orientation. After the container is emptied, the signaling indicator automatically rotates back to its initial oriented position on top of the refuse container lid.

None of these flag/signaling devices can stay in a vertical orientation, where the shape of the raised flag signaling device always causes the lid to fall back to a closed position on the container.

It has currently become popular to have single driver trash-refuse trucks with pivotable arms that pick up a filled up trash-refuse container, and raise the filled up container to be emptied in an upside down position into the trash-refuse truck. See for example, U.S. Pat. No. 5,837,945 to Cornwell et al.; U.S. Pat. No. 6,139,244 to VanRaden, which are incorporated by reference in their entirety. And see for example, U.S. Published Patent Applications: 2005/0002764 and 2006/0153667 to Pruteanu et al., which are incorporated by reference in their entirety.

These mechanisms merely raise and empty the trash-refuse containers, and return the containers to vertical orientations with the lids handing in an open position. The resultant open hanging lid position does not provide a clear and adequate indicator to the user that the trash-refuse container has been emptied.

Thus, the need exists for solutions to the above problems with the prior art.

### SUMMARY OF THE INVENTION

A primary objective of the present invention is to provide systems, devices, and methods for providing a trash/refuse container signal Indicator that continuously keeps the trash/refuse container lid in a closed position.

A secondary objective of the present invention is to provide systems, devices, and methods for providing a trash/refuse container lid signal Indicator that can be physically moved from a down position over a closed lid on a trash/refuse container, and a fixed open vertical position a trash/refuse container.

A third objective of the present invention is to provide systems, devices, and methods for providing a trash/refuse container lid signal Indicator that can stay in a vertical orientation which limits the lid on the trash-refuse container to not be raised higher than an approximately 75 degree angle position, which allows the lid on the trash-refuse container to be able to fall back to a closed position on the trash-refuse container.

A fourth objective of the present invention is to provide systems, devices and methods for providing a trash flag that protects the trash-refuse container from damage by filling up from rain water, snow, etc., and remains in a raised position to indicate when trash in the trash-refuse container has been picked up (emptied).

A preferred embodiment can include a trash flag signaling device that can be used with a trash-refuse container having a pair of rear wheels, an upper rear extending handle, and a lid hingedly attached to the top opening of the trash-refuse container. The trash flag signaling device can include a base with a clamp plate, and arm extending from the base, and a flag end at the end of the arm. The base of the trash flag signaling device can be clamped to the handle of the trash-refuse container. The clamped base can pivot about the trash-refuse container handle in a friction fit between a down position where the flag end can lay over the lid of the trash-refuse container, and can move to a raised angled position extending above the lid of the trash-refuse container. In the down position, the flag end can hold the lid down to keep the lid from flopping open. In the raised position, the lid can be opened to a stop which limits the lid to opened to less than a 90-degree angle position relative to the opening to the trash-refuse container.

During use the trash-refuse container can be filled up, and the hinged lid moved to a closed position. After clamping the base of the trash flag signaling device to the handle of the trash-refuse container, the flag end can be laid on the top of the closed lid. A trash truck can pick up the filled trash-refuse container with an articulating arm lifting it over an upper opening to the trash truck and turns the filled trash-refuse container upside down. At this point, gravity causes the contents of the trash-refuse container to drop downward pushing the closed lid open and move to an angled opening limited by the stop in the trash flag signaling device.

After all the contents are emptied, the articulating arm lifts and reverses the orientation of the trash-refuse container to place it back in the original position, with the trash flag signaling device remaining in a vertical upright angled raised position.

The vertical upright angled raised position of the trash flag signaling device on the upright trash-refuse container is a signal indicator to the user/customer that the trash-refuse container has been emptied and is ready to be reused. If the lid remains in an angle open position, the weight of the lid can on its' own cause the lid to fall back and become closed over the top of the trash-refuse container.

Further objects and advantages of this invention will be apparent from the following detailed description of the presently preferred embodiments which are illustrated schematically in the accompanying drawings.

### BRIEF DESCRIPTION OF THE FIGURES

The drawing figures depict one or more implementations in accord with the present concepts, by way of example only, not by way of limitations. In the figures, like reference numerals refer to the same or similar elements.

FIG. 1A is a front perspective view of the novel trash container signal indicator device.

FIG. 1B is a rear perspective view of the novel trash container signal indicator device of FIG. 1A.

FIG. 2A is a front view of the novel trash container signal indicator device of FIG. 1A.

FIG. 2B is a rear view of the novel trash container signal indicator device of FIG. 1A.

FIG. 3A is a right side view of the signal indicator device of FIGS. 1A and 2A.

FIG. 3B is a left side view of the signal indicator device of FIGS. 1A and 2A.

FIG. 4A is a right side perspective view of the signal indicator device of FIGS. 1A and 2A.

FIG. 4B is a left side perspective view of the signal indicator device of FIGS. 1A and 2A.

FIG. 5 is an exploded perspective view of the signal indicator device of the preceding FIGURES.

FIG. 6A is a rear right perspective view of the signal indicator device of the preceding figures installed on a filled up trash-refuse container with lid in a closed position.

FIG. 6B is an upper enlarged perspective view of the signal indicator device on top of the lid of the filled up trash-refuse container of FIG. 6A.

FIG. 7A is a left side view of the installed signal indicator device on the filed up trash refuse container with closed lid of FIGS. 6A-6B.

FIG. 7B is an upper enlarged perspective view of the signal indicator device on top of the lid of the filled up trash-refuse container of FIG. 7A.

FIG. 8A is a rear view of a side loading trash-refuse truck with a side arm picking up the filled-up trash-refuse container of FIGS. 7A-7B.

FIG. 8B is another rear view of the side loading trash-refuse truck of FIG. 8A raising up the filled-up trash-refuse container of FIGS. 7A-7B, and releasing the contents of the filled-up trash-refuse container into the top of the trash-refuse truck.

FIG. 9A is an upside down view of the trash-refuse container in FIG. 8B upside down emptied, where the signal indicator has limited to lid being opened to less than approximately 90 degrees.

FIG. 9B is an enlarged view of the lid of the empty trash-refuse container of FIG. 9A limited in being opened by the signal indicator device.

FIG. 9C is another view of FIG. 9B with the lid opened to a maximum position.

FIG. 10A is another rear right perspective view of the signal indicator device of the preceding FIGURES remaining in the raised flag position after the emptied trash-refuse container is back in a working position, and the lid has fallen down to a closed position on the emptied trash-refuse container.

FIG. 10B an upper enlarged perspective view of the signal indicator device remaining in the raised flag position on top of the lid of the emptied trash-refuse container of FIG. 10A.

FIG. 11A is a left side view of the raised signal indicator device on the emptied trash-refuse container of FIGS. 9A-9B.

FIG. 11B is an upper enlarged view of the of the raised signal indicator device on the emptied trash-refuse container of FIG. 10A.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

A list of component number labels is listed below:
1 Flag indicator device
10 Flag
12 upper side edge of flag
14 lower side edge of flag
16 outer end edge of flag
18 bottom step edge of flag
20 arm section
30 Flag handle member
32 upper side edge of handle
34 top step edge
35 first cut-out for clamp
36 concave curve lower surface portion
37 second cut-out for clamp
38 bottom edge of handle
40 clamp plate
42 first clamp base
44 clamp arc midportion
46 second clamp base
52 first set of screw/bolt
52N nut
54 second set of screw/bolt
54N nut
100 trash-refuse container
102 upper exterior edge of trash-refuse container
110 left rear wheel
120 right rear wheel
130 handle on trash-refuse container
132 left strut member
134 right strut member
140 lid
142 left lid arm
144 right lid arm
200 trash refuse truck
205 open top of truck
210 container clamp
220 articulating arm

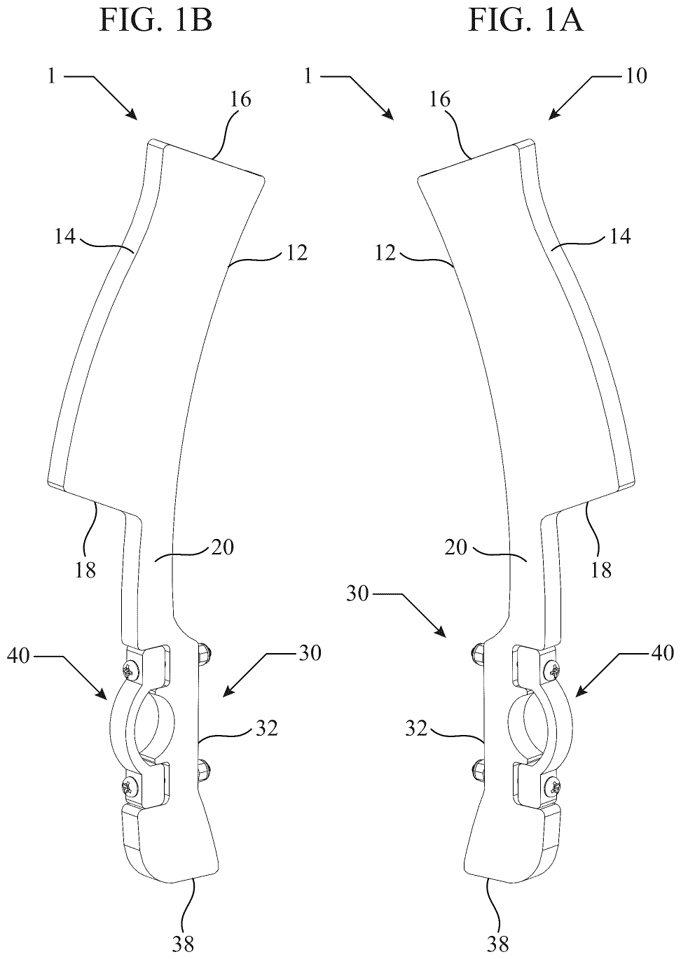

FIG. 1A is a front perspective view of the novel trash container signal indicator device 1. FIG. 1B is a rear perspective view of the novel trash container signal indicator device 1 of FIG. 1A.

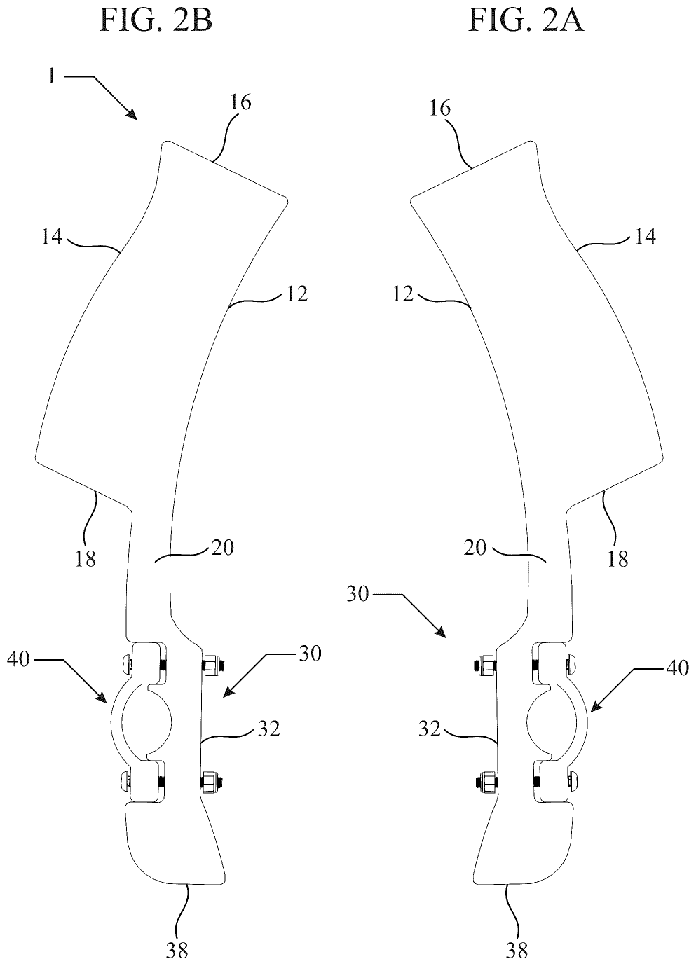

FIG. 2A is a front view of the novel trash container signal indicator device 1 of FIG. 1A. FIG. 2B is a rear view of the novel trash container signal indicator device 1 of FIG. 1A.

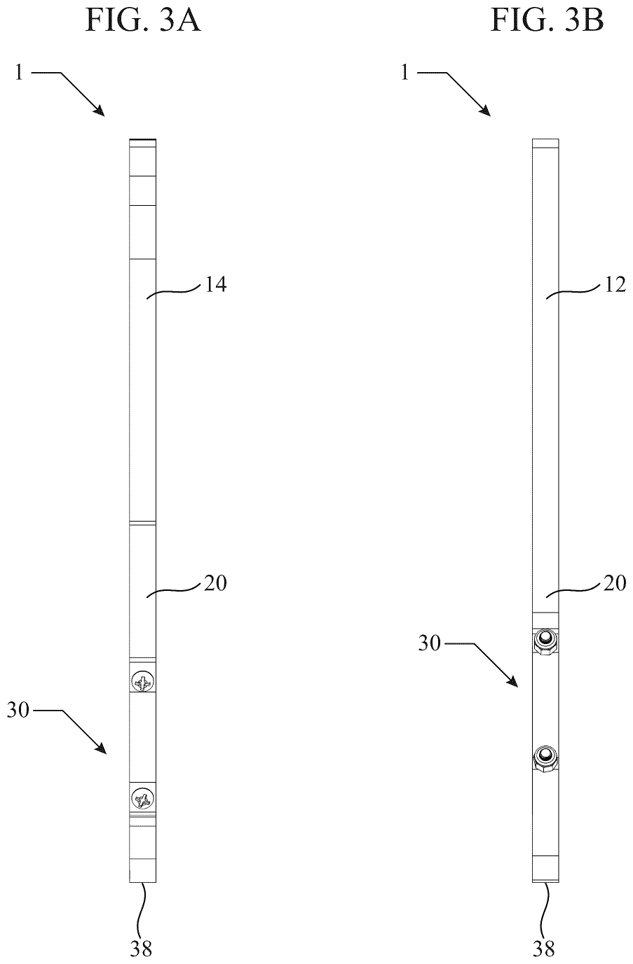

FIG. 3A is a right side view of the signal indicator device 1 of FIGS. 1A and 2A. FIG. 3B is a left side view of the signal indicator device 1 of FIGS. 1A and 2A.

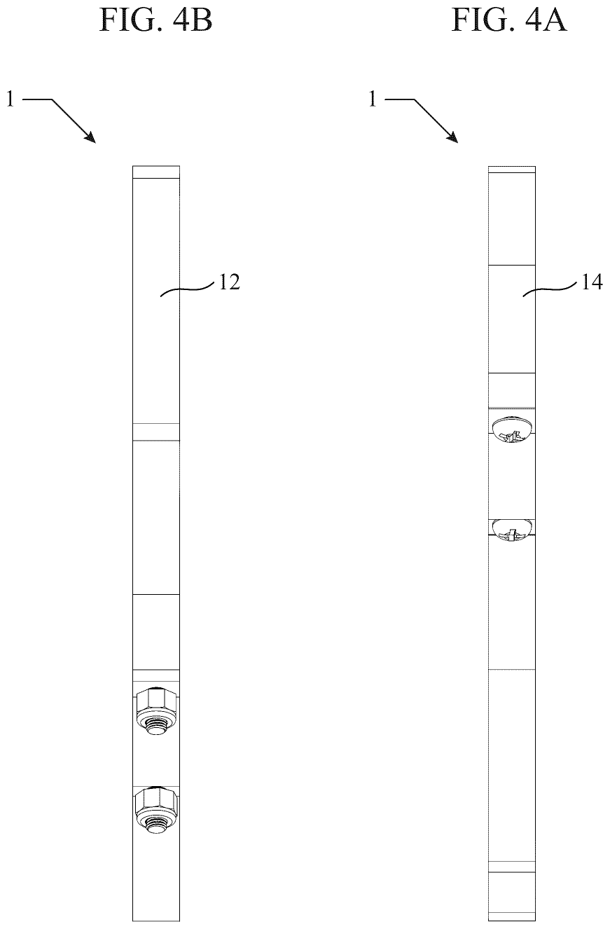

FIG. 4A is a right side perspective view of the signal indicator device 1 of FIGS. 1A and 2A. FIG. 4B is a left side perspective view of the signal indicator device of FIGS. 1A and 2A.

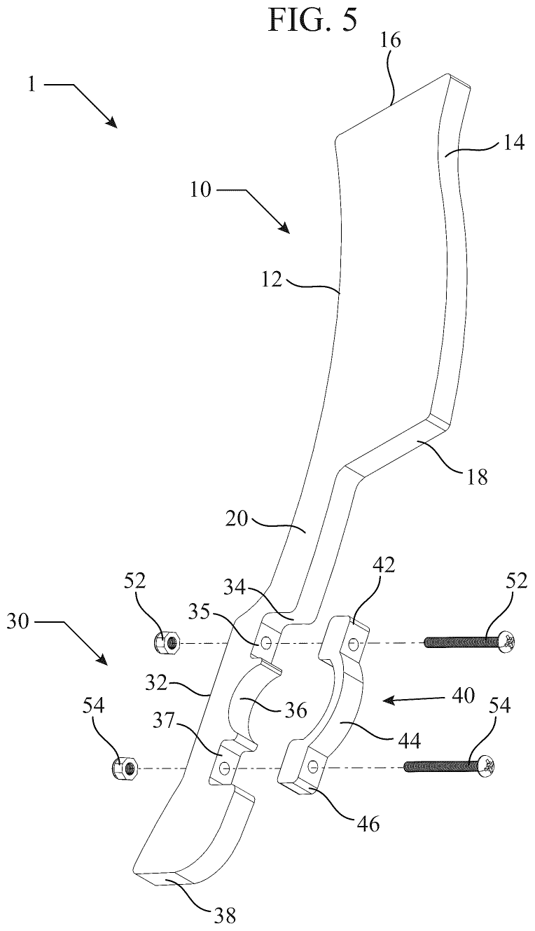

FIG. 5 is an exploded perspective view of the signal indicator device 1 of the preceding FIGURES.

Referring to FIGS. 1-5, the flag 10, arm and flag handle member 30 can be molded from UV protected plastic, and the like, to be able to last outdoors under winter and summer conditions.

Referring to FIGS. 1-5, a preferred embodiment of the signal indicator device 1 can be made from have an overall length between the outer end 16 of the flag 10 and the bottom edge 38 of the flag handle member 30 being approximately 15 inches.

The flag portion 10 can have a generally rectangular shape with a length of approximately 7 inches, width of approximately 2.5 inches and thickness of approximately ½ inch. The upper side edge 12 of the flag 10 can have a generally elongated concave curved surface, and a flat outer end edge 16, and a lower side edge 14 having a generally upper concave curve surface which passes into a generally convex curved surface, which meets a bottom step edge 18. Extending below the flag 10 is a short arm section 20, which runs to a flag handle member 30.

The flag handle member 30 can have a generally elongated upper side edge 32 having a flat surface that extends to about a rounded portion to a bottom edge 38.

The opposite side of the flag handle member 30 can have a top step edge 34, with a first cut-out 35 for clamp 40, and a concave curve lower surface portion 36 above a second cut-out 37 for the clamp, and extends to a rounded portion to the bottom edge 38.

The clamp plate 40 can be a separate piece of molded from UV protected plastic, and the like, to be able to last outdoors under winter and summer conditions.

The clamp plate 40 can have a first clamp base 42 which can fit within the first cut-out 35 of the flag handle member 30, and a second clamp base 46 that can fit within the second cut-out 37 of the flag handle member 30, with a clamp arc midportion 44 there between.

A first screw/bolt 52 can pass through aligned through-holes in the first clamp base 42 and first cut-out 35 of the flag handle member 30 with first nut 52N to attach the clamp plate 40 to the flag handle member 30. A second screw/bolt 54 can pass through aligned through-holes in the second clamp base 46 and second cut-out 37 of the handle with a second nut 54N to attach the clamp plate 40 to the flag handle member 30.

A preferred embodiment of the invention can include stainless steel bolt/screws 52, 54 and stainless-steel nuts 52N, 54N.

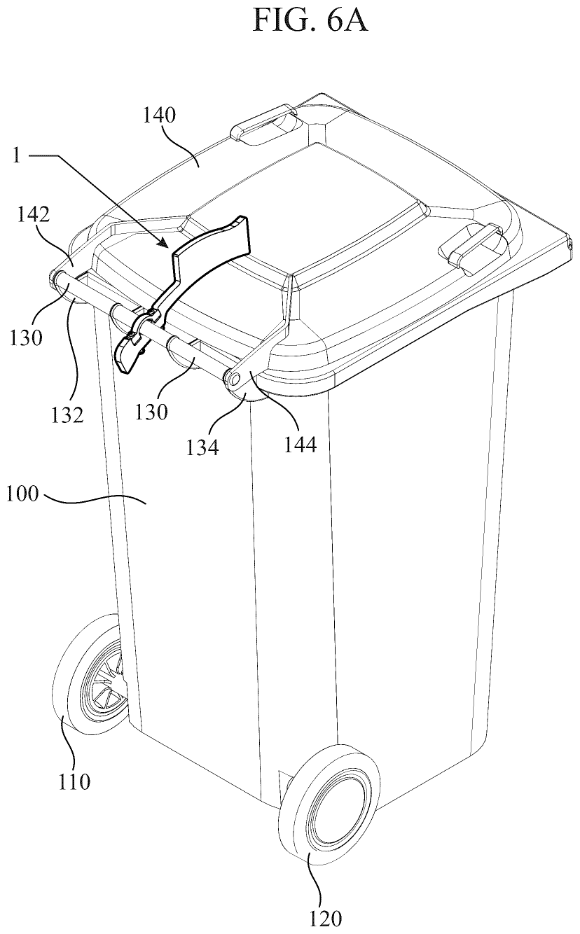

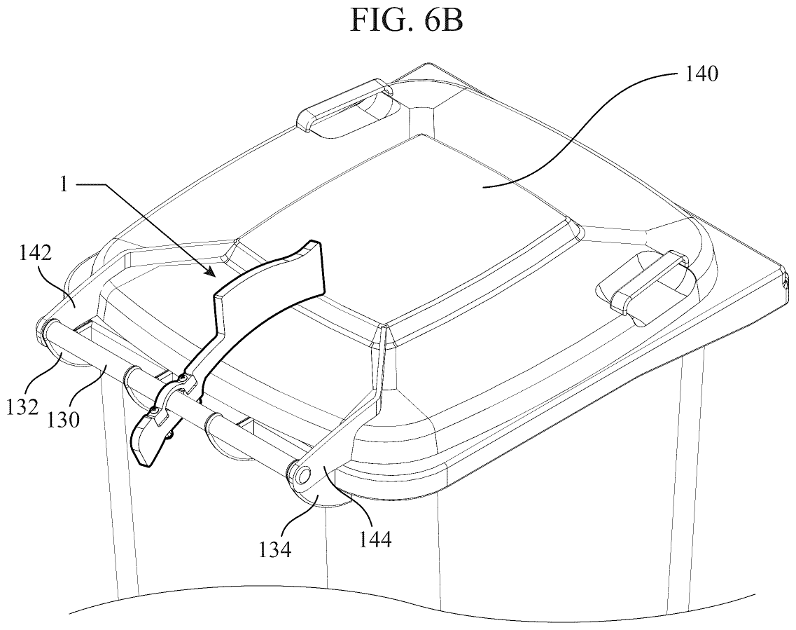

FIG. 6A is a rear right perspective view of the signal indicator device 1 of the preceding figures installed on a filled-up trash-refuse container 100 with lid 140 in a closed position.

FIG. 6B is an upper enlarged perspective view of the signal indicator device 1 on top of the lid 140 of the filled up trash-refuse container 100 of FIG. 6A.

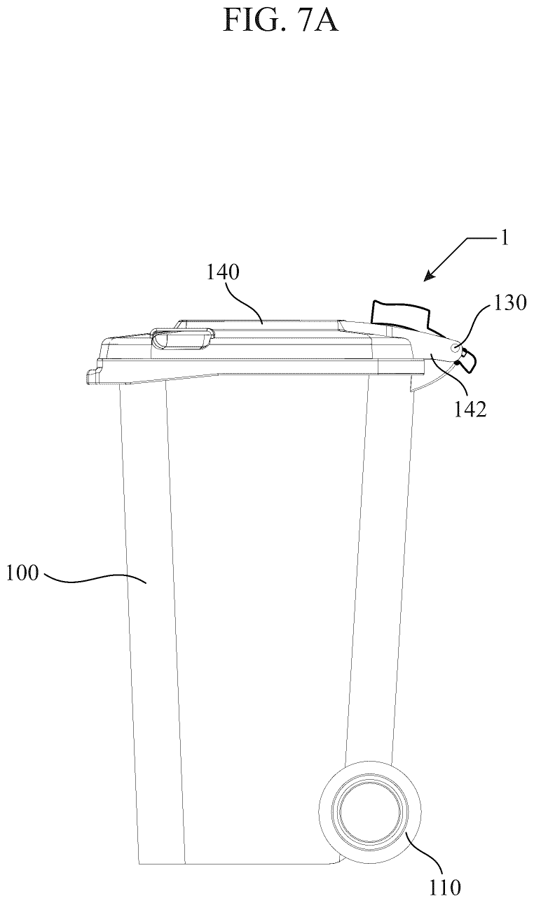

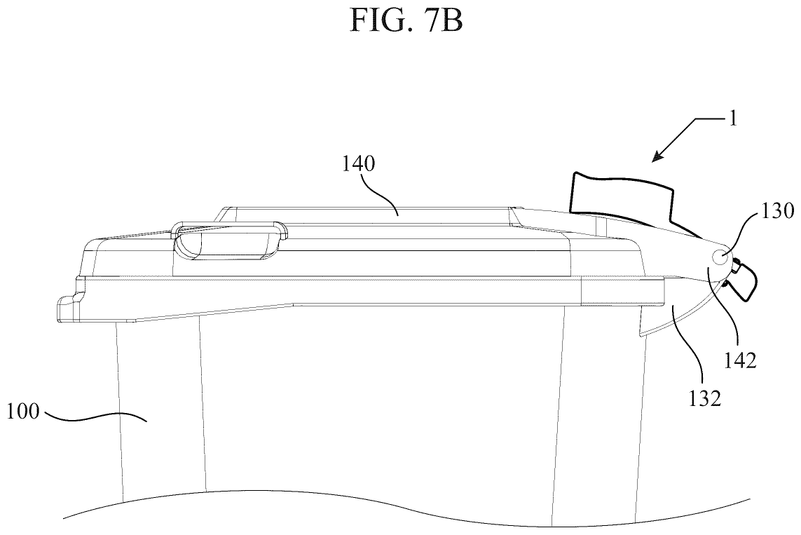

FIG. 7A is a left side view of the installed signal indicator device 1 on the filled up trash refuse container 100 with closed lid 140 of FIGS. 6A-6B.

FIG. 7B is an upper enlarged perspective view of the signal indicator device 1 on top of the lid 140 of the filled up trash-refuse container 100 of FIG. 7A.

Referring to FIGS. 1-7B, the signal indicator device 1 can be used with a trash-refuse container 100 having a left rear wheel, right rear wheel 120, which allow the trash-refuse container 100 to be moved thereby. The trash-refuse container 100 can include a lid 140 that can move from a closed position to an open position by rotating along a left lid arm 142 relative to the left end of a fixed handle 130, and rotating along a right lid arm 144 relative to the right end of the fixed handle 130. The handle 130 can be fixed to the container 100 by a left strut member and a right strut member. The trash-refuse container 100 shown in the figures can be made from molded plastic, and the like, and can be typically used to move trash-refuse inside having a capacity of up to approximately 96 gallons, with a weight capacity of up to approximately 150 pounds.

Referring to FIGS. 1-7B, the flag indicator device 1 can be assembled by positioning the handle member 30 of the device 1 under the trash-refuse container handle 130 with the upper side edge of the flag 12 resting on top of the lid 140 of the trash-refuse container 100. Next, the clamp plate 40 is placed over the top of the trash-refuse container handle 130, so that the first clamp base 42 fits within the first cut-out for the clamp 35, and the second clamp base 46 fits within the second cut-out for the clamp 37. Next the first screw/bolt 52 is pushed through the aligned openings in the first clamp base 42 and first cut-out 35 and fixed in place by first nut 52N, while the second screw/bolt 54 is pushed through the aligned openings in the second clamp base 46 and second cut-out 37 and fixed in place by second nut 54N. The respective nuts 52N, 54N are screwed thereon until the flag handle member 30 and the clamp plate 40 are securely fastened and can move together relative to the trash-refuse container handle 130.

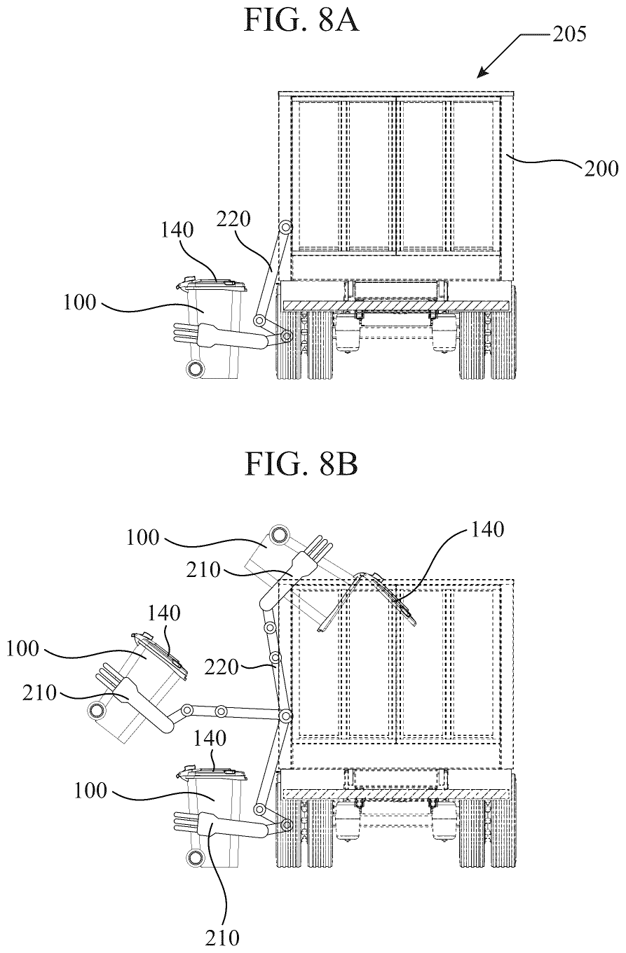

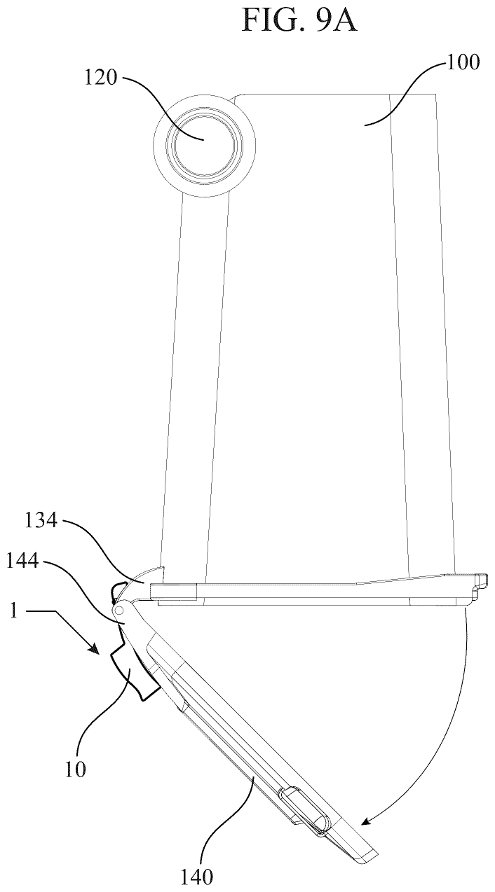

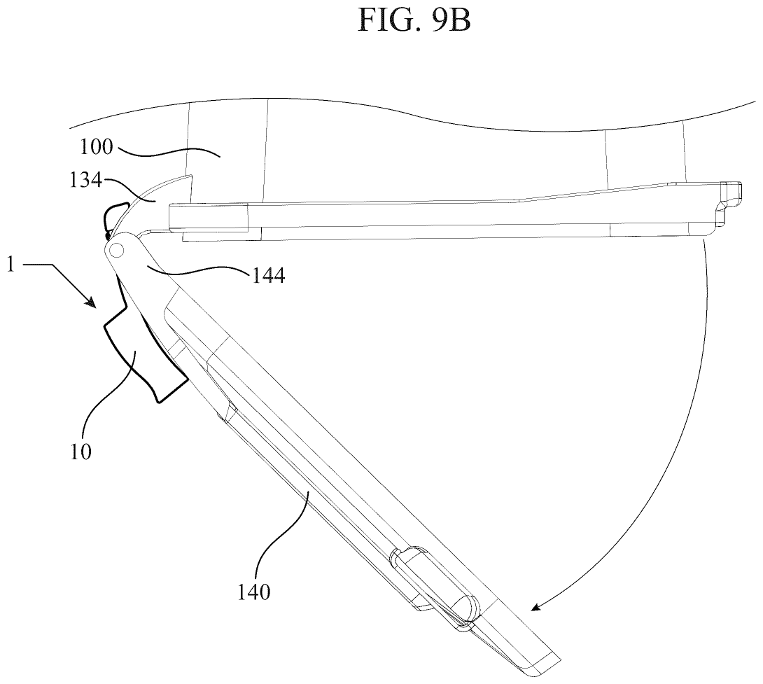

FIG. 8A is a rear view of a side loading trash-refuse truck 200 with a side articulating arm 220 picking up the filled-up trash-refuse container 100 with closed lid 140 of FIGS. 7A-7B by a clamp ring.

FIG. 8B is another rear view of the side loading trash-refuse truck 200 of FIG. 8A showing different stages of raising up the filled-up trash-refuse container 100 of FIGS. 7A-7B, by the articulating arm 220 and releasing the contents of the filled-up trash-refuse container 100 into the top 205 of the trash-refuse truck 200. As the refuse-container 100 is turned upside down the lid 140 of the trash-refuse container 100 pivots to an open position which allows the contents inside the container 100 to drop into the open top 205 of the trash-refuse truck 200.

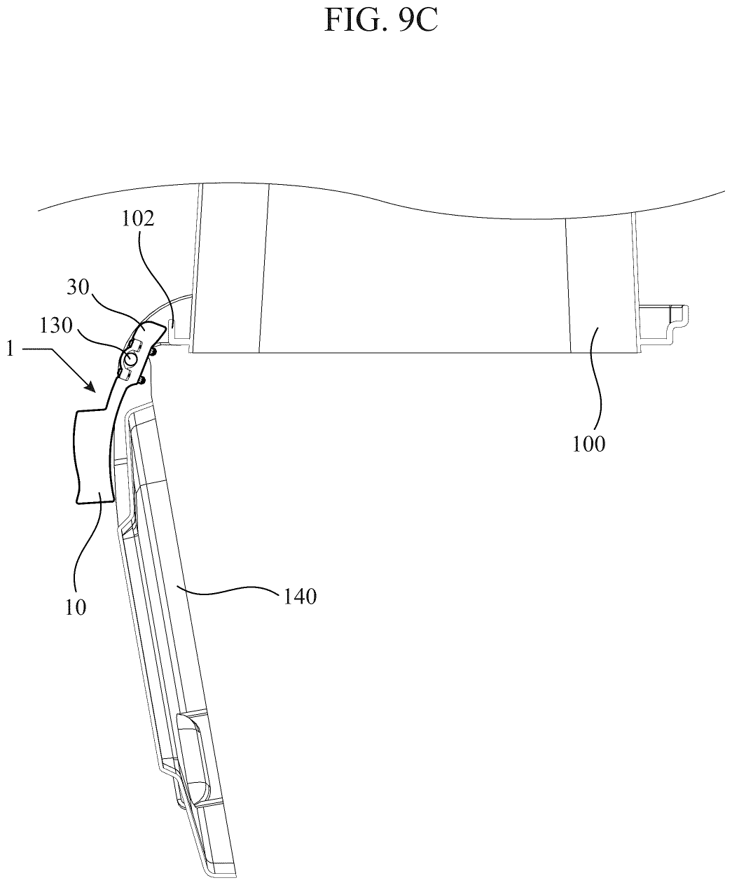

FIG. 9A is an upside down view of the trash-refuse container 100 in FIG. 8B upside down emptied, where the signal indicator 1 is beginning to limit the lid 140 being opened to less than approximately 90 degrees.

FIG. 9B is an enlarged view of the lid of the empty trash-refuse container 100 of FIG. 9A being opened by the signal indicator device 1.

FIG. 9C is another view of FIG. 9B with the trash-refuse container 100 in cross-sectional view with the lid 140 opened to a maximum position by being limited by the base of the flag handle member 30 which abuts against an upper exterior edge 102 of the trash-refuse container 100.

After all the contents of the trash-refuse container 100 are emptied, the articulating arm 220 (shown in FIG. 8B lifts and reverses the orientation of the trash-refuse container to place it back in the original position, with the trash flag signaling device 1 remaining in a vertical upright angled raised position.

The vertical upright angled raised position of the trash flag 1 signaling device on the upright trash-refuse container 100 is a signal indicator to the user/customer that the trash-refuse container 100 has been emptied and is ready to be reused.

If the lid 140 remains in an angle open position, the weight of the lid 140 can on its' own cause the lid 140 to fall back and become closed over the top of the trash-refuse container 100.

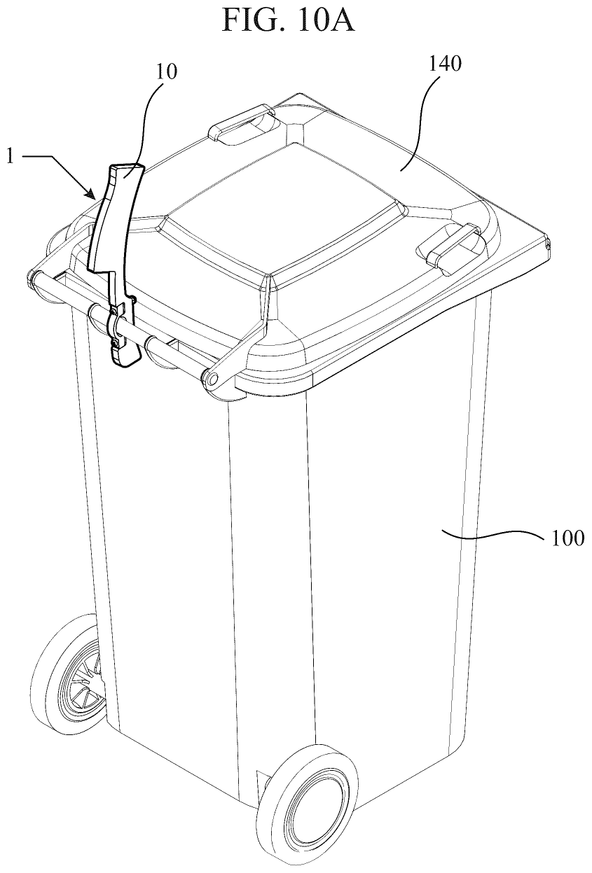

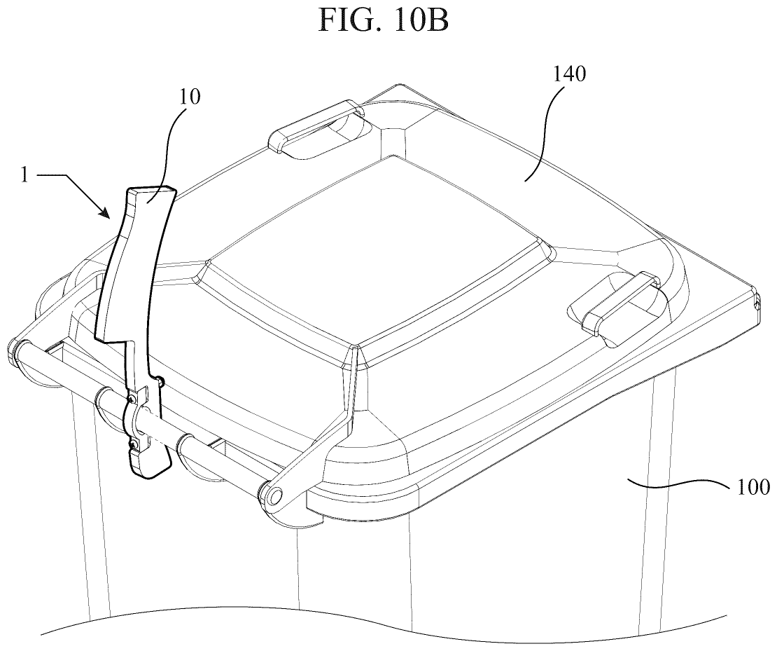

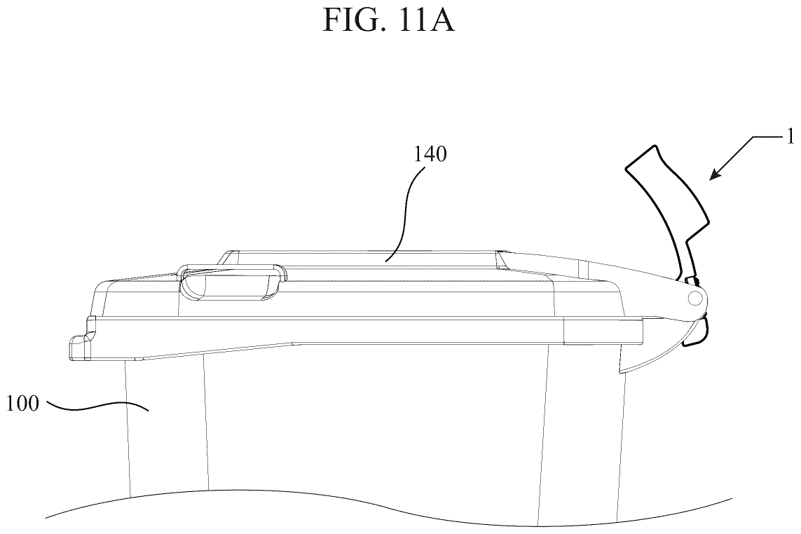

FIG. 10A is another rear right perspective view of the signal indicator device 1 of the preceding FIGURES remaining in the raised flag position after the emptied trash-refuse container 100 is back in a working position, and the lid 140 has fallen down to a closed position on the emptied trash-refuse container 100.

FIG. 10B an upper enlarged perspective view of the signal indicator device 1 remaining in the raised flag position on top of the lid 140 of the emptied trash-refuse container 100 of FIG. 10A.

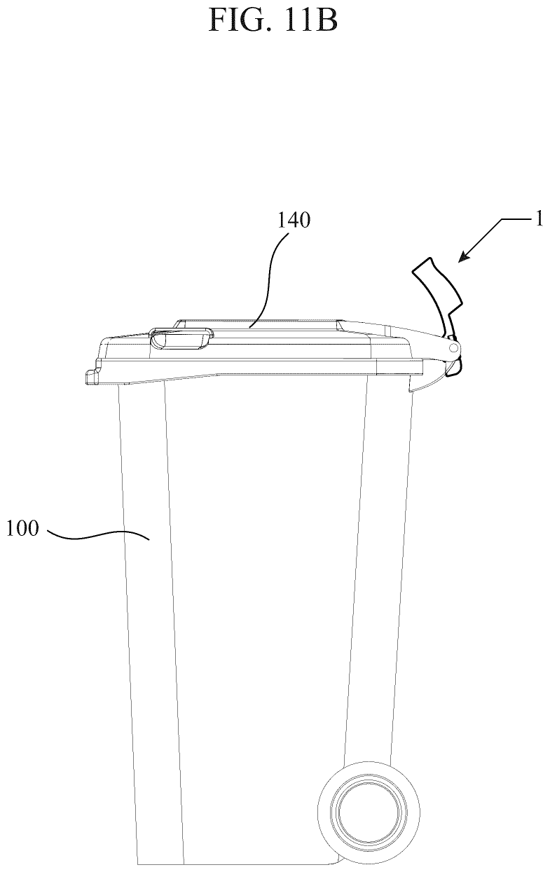

FIG. 11A is a left side view of the raised signal indicator device 1 on the emptied trash-refuse container 100 of FIGS. 9A-9B. FIG. 11B is an upper enlarged view of the of the raised signal indicator device 1 on the emptied trash-refuse container 100 of FIG. 10A.

The vertical upright angled raised position of the trash flag signaling device 1 on the upright trash-refuse container 100 is a signal indicator to the user/customer that the trash-refuse container 100 has been emptied and is ready to be reused. If the lid 140 remains in an angle open position, the weight of the lid 140 can on its' own cause the lid to fall back and become closed over the top of the trash-refuse container 100.

The term “approximately”/ “approximate” can be +/−10% of the amount referenced. Additionally, preferred amounts and ranges can include the amounts and ranges referenced without the prefix of being approximately.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A flag indicator device for trash containers, comprising:
a flag end of an elongated member; and
a mounting end of the elongated member, the mounting end being clamped about a handle of a trash container, wherein the flag end has a down position overlaying a closed lid on the trash container, and a raised vertical position less than being perpendicular to the closed lid of the container, wherein the raised position of the flag end prevents the lid from being raised to a vertical position perpendicular to the closed lid of the container.

2. The flag indicator device of claim 1, wherein the flag end includes:
a generally rectangular configuration having an upper surface having a slight concave portion that raises to a convex curved portion, and a lower surface having a generally concave curved surface.

3. The flag indicator device of claim 1, wherein the mounting end includes:
a clamp plate having a front surface with a pair of notches separated by a concave curved portion;
a handle cover having a pair of base ends which fit into the pair of notches on the clamp plate, and a concave curved cover portion therebetween; and
fasteners for attaching the pair of base ends to the pair of notches, the fasteners, selected from bolts, screws and nuts, wherein the mounting end forms a friction fit to be rotatable to different rotated positions about the handle of the trash container.

4. The flag indicator device of claim 3, wherein the elongated member with the flag part and the clamp plate are formed from one piece of plastic.

5. The flag indicator device of claim 2, wherein the mounting end includes:
a clamp plate having a front surface with a pair of notches separated by a concave curved portion;
a handle cover having a pair of base ends which fit into the pair of notches on the clamp plate, and a concave curved cover portion therebetween; and
fasteners for attaching the pair of base ends to the pair of notches, the fasteners, selected from bolts, screws and nuts, wherein the mounting end forms a friction fit to be rotatable to different rotated positions about the handle of the trash container.

6. The flag indicator device of claim 5, wherein the elongated member with the flag part and the clamp plate are formed from one piece of plastic.

7. A trash flag signaling device for use with a trash-refuse container having a pair of rear wheels, an upper rear extending handle, and a lid hingedly attached to the top opening of the trash-refuse container, the device comprising:
a base with a clamp plate;
an arm extending from the base; and
a flag end at the end of the arm;
wherein clamping the base to the handle of the trash-refuse container causes a friction fit to allow the handle to pivot where the flag end is moveable from a down position to lay over the lid of the trash-refuse container to be move to a raised angled position extending less than approximately 90 degrees above the lid of the trash-refuse container, wherein in the down position, the flag end keeps the lid from flopping open, and in the raised position, the lid is limited by a stop so that the lid is open to less than a 90-degree angle position relative to the opening to the trash-refuse container.

8. The trash flag signaling device of claim 7, wherein the base includes:
fasteners for attaching the clamp plate to a clamp cover plate, wherein each of the clamp plate and clamp cover plate include opposing facing concurve surface portions.

9. The trash flag signaling device of claim 8, wherein the clamp plate, the arm and the flag end are formed from one piece of plastic.

10. The trash flag signaling device of claim 8, wherein the flag end includes:
a generally rectangular configuration having an upper surface having a slight concave portion that raises to a convex curved portion, and a lower surface having a generally concave curved surface.

11. A method of indicating trash has been picked up with a trash flag indicator, comprising the steps of:
providing an elongated member with an enlarged flag end, and an opposite mounting end;
clamping the mounting end about a handle of a trash-refuse container having a closed lid hinged to the container adjacent to the handle, the container being filled with refuse;
positioning the flag end over the closed lid by rotating the mounting end relative to the handle;
clamping about the filled container with an articulating arm from a trash vehicle;
raising the filled up container with the articulating arm, and turning the filled container upside down into an upper opening of the trash vehicle, emptying the container;
limiting opening of the lid by the flag end by a portion of the mounting end abutting against an upper exterior portion of the emptied container, wherein the flag end is moved to an extended upright position;
moving the emptied container back to an upright position on ground level, while the enlarged flag end remains in the extended upright position; and
dropping the lid by gravity to a closed position over the container, wherein the remaining extended upright position of the enlarged flag end indicates to others that the trash-refuse container has been emptied, and is ready to be reused.
